(19) United States
(12) Patent Application Publication
(10) Pub. No.: US 2013/0055520 A1
(43) Pub. Date: Mar. 7, 2013

(54) WIPER BLADE UNIT

(71) Applicants: Lothar Urbanek, Diepenbeek (BE); Nathalie Stroobants, Zelem (BE); Hervé Bratec, Wilsele (BE); Guido Tuyls, Bunsbeek (BE); Robert Vertongen, Heusden-Zolder (BE); Johan Camps, Bunsbeek (BE)

(72) Inventors: Lothar Urbanek, Diepenbeek (BE); Nathalie Stroobants, Zelem (BE); Hervé Bratec, Wilsele (BE); Guido Tuyls, Bunsbeek (BE); Robert Vertongen, Heusden-Zolder (BE); Johan Camps, Bunsbeek (BE)

(73) Assignee: ROBERT BOSCH GMBH, Stuttgart (DE)

(21) Appl. No.: 13/580,067

(22) PCT Filed: Dec. 27, 2010
(86) PCT No.: PCT/EP2010/070759

§ 371 Date: Nov. 19, 2012

(30) Foreign Application Priority Data
Feb. 19, 2010 (DE) 10 2010 002 162.8

(51) Int. Cl. B60S 1/04

(52) U.S. Cl. 15/250.351

(57) ABSTRACT

The invention is based on a wiper blade unit, in particular for a joint-free wiper blade (10a; 10b), having a liquid guiding body (12a; 12b) which has at least one liquid guiding bridge (14a; 14b) which, when in an operating state, is arranged on a side (18a; 18b) facing away from a wiper blade main flow side (16a; 16b).

### BACKGROUND OF THE INVENTION

U.S. 00D418,103 discloses a joint-free wiper blade which has a wiper blade adaptor. A spoiler element is arranged on one side of the wiper blade adaptor, said spoiler element, as viewed in an operating state, forming an approach flow surface running obliquely with respect to a windshield and therefore, in an operating state, advantageously guiding an airstream flow over the wiper blade and increasing the press-on pressure of the wiper blade against the windshield.

### SUMMARY OF THE INVENTION

A wiper blade unit is proposed, in particular for a joint-free wiper blade, with a liquid guiding body which has at least one liquid guiding bridge which, as viewed in an operating state, is arranged on a side facing away from a wiper blade main flow side. In this context, a “liquid guiding bridge” is to be understood in particular as meaning a part of the liquid guiding body which is provided, i.e. in particular especially designed and/or equipped in order to guide liquid past a component region, in particular a component which is separated from the liquid guiding body, preferably past a component region of a wiper blade adaptor of the wiper blade. For this purpose, the liquid guiding bridge has in particular in a wiper blade longitudinal direction, as viewed in an operating state, a length of greater than 1 cm and preferably greater than 2 cm and, transversely with respect to the wiper blade longitudinal direction, preferably has an extent which is greater than 2 mm and in particular is greater than a wall thickness of the liquid guiding bridge itself. A “wiper blade longitudinal direction” is intended to be understood in particular as meaning a direction in which a wiper strip of the wiper blade, which wiper strip is provided for direct contact with a windshield, has its greatest extent. A “wiper blade main flow side” is intended to be understood in particular as meaning a longitudinal side of a wiper blade, which longitudinal side faces an airstream flow at least in a majority of operating positions of the wiper blade. At least one spoiler element and in particular a flow surface of a spoiler element, which flow surface is provided for guiding the airstream flow over the wiper blade and for increasing a press-on force of the wiper strip against the windshield, is preferably also located on the wiper blade main flow side. Advantageous guidance of liquid can be achieved by means of a corresponding configuration. In particular, it is advantageously possible for liquid barriers, at which liquid, in particular cleaning liquid, is retained during operation and could flow in an nondesirable manner over the wiper blade, to be at least partially bridged. Undesirable splashes on the windshield can be at least reduced by this means.

If the liquid guiding bridge forms at least one end, and particularly preferably two ends, of the liquid guiding body in a wiper blade longitudinal direction, barriers caused by the liquid guiding body itself can advantageously be bridged. In this case, an “end in the wiper blade longitudinal direction” is understood in particular as meaning an outermost part of the liquid guiding body in the wiper blade longitudinal direction.

In a further refinement of the invention, it is proposed that the liquid guiding body has at least one spoiler element arranged on the wiper blade main flow side. In this case, a “spoiler element” is intended to be understood in particular as meaning an element which is specifically provided in order, when an airstream flow approaches, to guide the latter with a flow guiding surface over the wiper blade and therefore in particular to increase a press-on force of the wiper blade against the windshield. In this case, the spoiler element preferably has, transversely with respect to a wiper blade longitudinal direction, a rising flow guiding surface on the wiper blade main flow side, as viewed in the flow direction, and is particularly advantageously at least partially of concave design, preferably with a curved flow guiding surface. By means of a corresponding configuration, an advantageous flow and an advantageous press-on force of the wiper blade against the windshield can be achieved.

The wiper blade unit and a wiper blade adaptor are preferably formed at least in the main part, in particular with respect to mass fractions, by separate components, as a result of which advantageous retrofittability is achievable and/or, particularly advantageously, the individual components can each be configured with regard to the function thereof. In this case, a “wiper blade adaptor” is intended to be understood in particular as meaning an adaptor via which the wiper blade is coupled to a wiper arm during operation. For this purpose, the wiper blade adaptor preferably has a receiving region for a wiper rod of the wiper arm. If the liquid guiding bridge extends in the wiper blade longitudinal extent beyond the wiper blade adaptor in at least one wiper blade longitudinal direction and preferably in both wiper blade longitudinal directions, an advantageous bridging of the wiper blade adaptor can be achieved. The liquid guiding bridge here preferably extends through on a side facing a wiper lip of the wiper strip under the wiper blade adaptor in the wiper blade longitudinal direction.

Furthermore, it is proposed that the liquid guiding body has at least one receiving region for a wiper blade adaptor. A “receiving region for a wiper blade adaptor” is intended to be understood in particular as meaning a region which is specifically provided for plugging the wiper blade adaptor onto said region and/or, particularly preferably, for introducing said wiper blade adaptor into said region. The receiving region here is particularly preferably at least partially formed by a recess within which, as viewed in an operating position, the wiper blade adaptor is at least partially arranged. By means of a corresponding configuration, a particularly compact construction which is favorable in terms of flow can be achieved.

If the wiper blade unit comprises at least one fastening unit which is provided for fastening to a wiper blade adaptor and/or to a wiper blade spring element, a flexible use and simple installation can be achieved. In this case, a “wiper blade spring element” is intended to be understood in particular as meaning a strip which is directly coupled to a wiper strip of the wiper blade and is provided in particular for ensuring adaptation of the wiper blade over a wiper blade length to a curved windshield with, at the same time, as uniform as possible a press-on pressure of the wiper strip against the windshield. The wiper blade spring element is preferably formed from a spring steel sheet.

If the fastening unit, as viewed in a wiper blade longitudinal direction, has at least one fastening element which is at least partially arranged upstream of the receiving region for the wiper blade adaptor, and at least one fastening element which is at least partially arranged downstream of the receiving region for the wiper blade adaptor, a particularly stable construction can be achieved.

The fastening unit may have different fastening elements appearing expedient to a person skilled in the art, such as rivets, screws, etc. However, the fastening unit particularly preferably has at least one clamping and/or latching element, thus enabling particularly simple and rapid installation to be achieved. In this case, a “clamping element” is intended to be understood in particular as meaning an element which brings about fastening by means of a clamping force, wherein, in particular, the clamping element is elastically deformed during installation in order to produce the clamping force. Furthermore, a “latching element” is intended to be understood in particular as meaning an element of a latching connection, in which, in order to produce the latching connection, at least one first element is moved counter to an elastic force in order, subsequently, moved by the elastic force, to engage in a form-fitting manner behind a second element of the latching connection. The fastening unit preferably comprises the element which is moved counter to an elastic force, preferably an internal elastic force of the element itself, in order to produce the latching connection. At least one fastening element is particularly preferably at least partially formed integrally with the liquid guiding body.

In a further refinement of the invention, it is proposed that the liquid guiding body comprises at least one clip which has a receiving region for a spoiler element. In this case, a “clip” is intended to be understood in particular as meaning an element which has an angled portion of more than 90°, wherein the receiving region is arranged in the concave region. By means of a corresponding configuration, a particularly advantageous connection to a spoiler element of the wiper blade, which connection is gap-free, as viewed in an operating state, can be achieved in particular in the airstream direction.

### BRIEF DESCRIPTION OF THE DRAWINGS

Further advantages emerge from the description below of the drawings. The drawings illustrate exemplary embodiments of the invention. The drawings, the description and the claims contain numerous features in combination. A person skilled in the art will expediently also consider the features individually and put them together to form meaningful further combinations.

In the drawings:

FIG. 1 shows a view of a wiper blade obliquely from above onto a wiper blade longitudinal side facing away from a wiper blade main flow side,

FIG. 2 shows an enlarged detail from FIG. 1,

FIG. 3 shows a view of the wiper blade obliquely from above onto the wiper blade main flow side of the wiper blade,

FIG. 4 shows a component illustration of a wiper blade unit of the wiper blade from FIG. 1 obliquely from above,

FIG. 5 shows the wiper blade unit from above,

FIG. 6 shows the wiper blade unit in a first side view,

FIG. 7 shows the wiper blade unit in a front view,

FIG. 8 shows the wiper blade unit in a second side view,

FIG. 9 shows the wiper blade unit in a view from below,

FIG. 10 shows a detail of a view of an alternative wiper blade obliquely from above onto a longitudinal side facing away from a wiper blade main flow side,

FIG. 11 shows a detail of a view of the alternative wiper blade obliquely from above onto the wiper blade main flow side of the wiper blade,

FIG. 12 shows a component illustration of a wiper blade unit of the wiper blade from FIG. 10 obliquely from above onto the longitudinal side facing away from the wiper blade main flow side,

FIG. 13 shows a view of the wiper blade unit of the wiper blade from FIG. 10 obliquely from above onto the wiper blade main flow side,

FIG. 14 shows the wiper blade unit from FIG. 12 from above,

FIG. 15 shows the wiper blade unit from FIG. 12 in a first side view,

FIG. 16 shows the wiper blade unit from FIG. 12 in a front view,

FIG. 17 shows the wiper blade unit from FIG. 12 in a second side view, and

FIG. 18 shows the wiper blade unit from FIG. 12 in a view from below.

### DETAILED DESCRIPTION

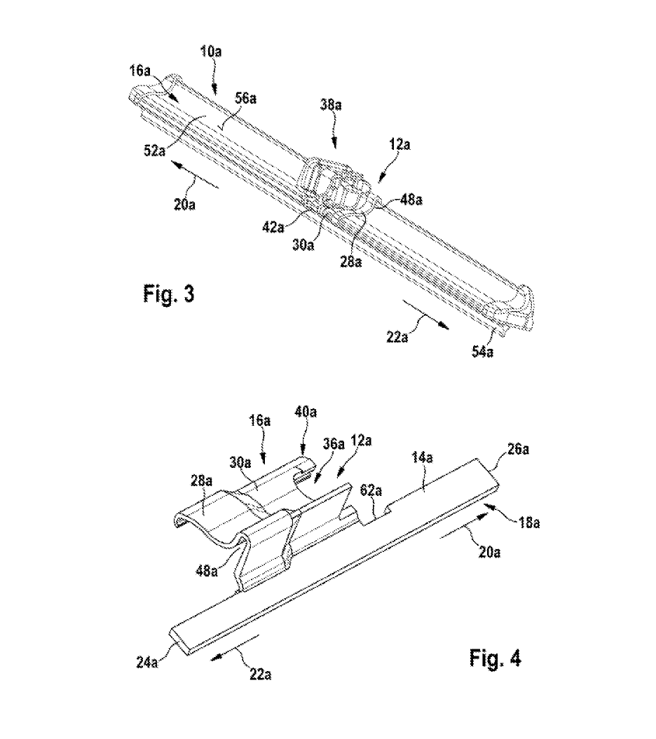

FIG. 1 shows a joint-free wiper blade 10a with a wiper strip 54a which is coupled to two strip-like wiper blade spring elements 42a, wherein only one of the wiper blade spring elements 42a is partially visible (FIG. 3). The wiper strip 54a has a wiper lip for coupling to a motor vehicle windshield (not illustrated specifically). The wiper blade 10a has a spoiler element 52a which, on a wiper blade main flow side 16a, comprises a flow surface 56a which is provided to guide an airstream flow over the wiper blade 10a during operation and, in the process, to increase a press-on force of the wiper blade 10a against the windshield (FIGS. 1 to 3). The flow surface 56a is of multi-curved design and is substantially in the shape of an S, as viewed in a wiper blade longitudinal direction 22a. In addition, the wiper blade 10a has a wiper blade adaptor 38a which is provided for direct coupling to a wiper arm of a windshield wiper (not illustrated specifically).

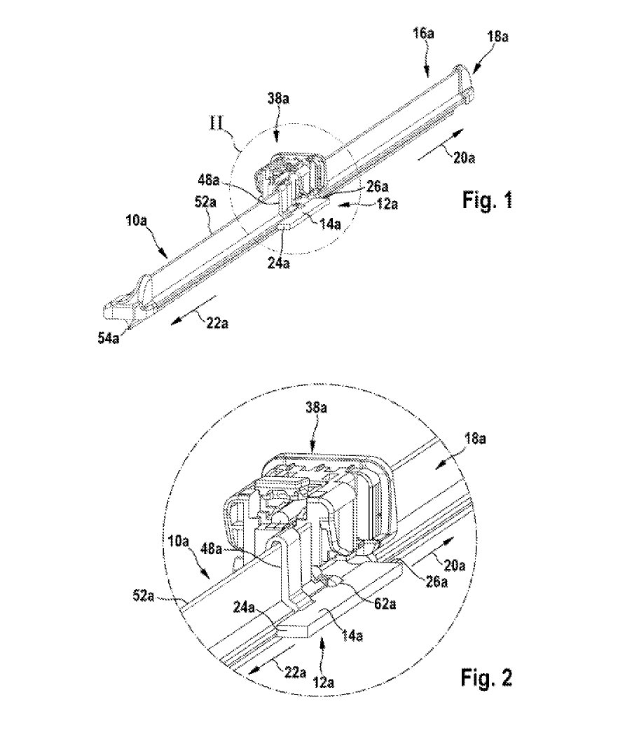

Furthermore, the wiper blade 10a comprises a wiper blade unit with a liquid guiding body 12a which is produced from plastic and has an integrally formed liquid guiding bridge 14a which, as viewed in an operating state, is arranged on a side 18a of the wiper blade 10a that faces away from the wiper blade main flow side 16a (FIGS. 1 to 9). The liquid guiding body 12a is formed by a separate component which is separate from the wiper blade adaptor 38a. The liquid guiding bridge 14a forms one end 24a, 26a of the liquid guiding body 12a in each wiper blade longitudinal direction 20a, 22a and, in both wiper blade longitudinal directions 20a, 22a, extends beyond the wiper blade adaptor 38a. On a side facing the wiper lip of the wiper strip 54a, the liquid guiding bridge 14a extends through under the wiper blade adaptor 38a in the wiper blade longitudinal direction 20a or 22a (FIGS. 1 and 2). In order to receive a latching element of the wiper blade adaptor 38a, a recess 62a is integrally formed on the liquid guiding bridge 14a (FIGS. 2, 4, 5 and 9). During the operation, liquid, in particular also cleaning liquid, can be guided past the wiper blade adaptor 38a by means of the liquid guiding bridge 14a below the latter, and liquid barriers caused by the wiper blade adaptor 38a can be avoided.

The liquid guiding body 12a has two spoiler elements 28a, 30a arranged on the wiper blade main flow side 16a (FIGS. 3, 4 to 9). The first spoiler element 28a is formed by a clip which has an angled portion of approx. 180° and which forms a receiving region 48a for the spoiler element 52a of the wiper blade 10a and which, in a fitted state, extends over the spoiler element 52a (FIGS. 2, 3 and 4). The second spoiler element 30a adjoins the first spoiler element 28a without a gap and is arranged in a region of a cutout in the spoiler element 52a of the wiper blade 10a. The spoiler elements 28a, 30a are matched by the shape thereof to the spoiler element 52a and each have an S-shaped flow surface, as viewed in the wiper blade longitudinal direction 22a.

The spoiler element 30a has fastening elements 58a, 60a of a fastening unit 40a, which is provided for fastening to the wiper blade spring elements 42a, said fastening elements being formed by clamping and latching elements. The fastening elements 58a, 60a are formed by U-shaped formations into which the strip-shaped wiper blade spring elements 42a are latched during installation. For this purpose, the liquid guiding body 12a is bent upwards elastically in order subsequently by means of an inner elastic force to latch with the U-shaped formations on the wiper blade spring elements 42a.

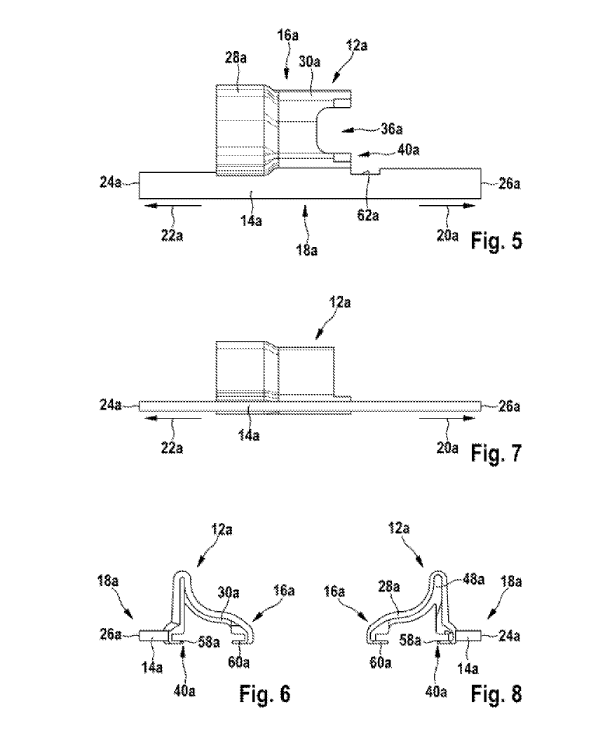

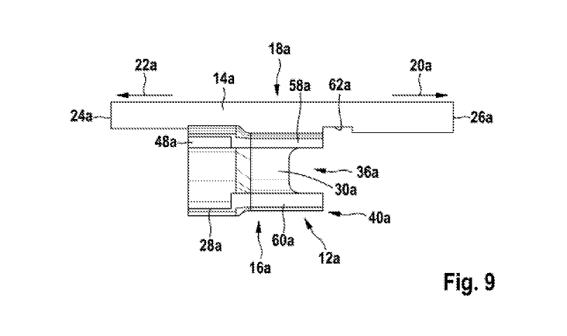

In order to achieve an advantageous transition to the wiper blade adaptor 38a, the liquid guiding body 12a or the spoiler element 30a has, on an end region facing in the wiper blade longitudinal direction 20a, a U-shaped formation with a receiving region 36a for the wiper blade adaptor 38a (FIGS. 5 and 9).

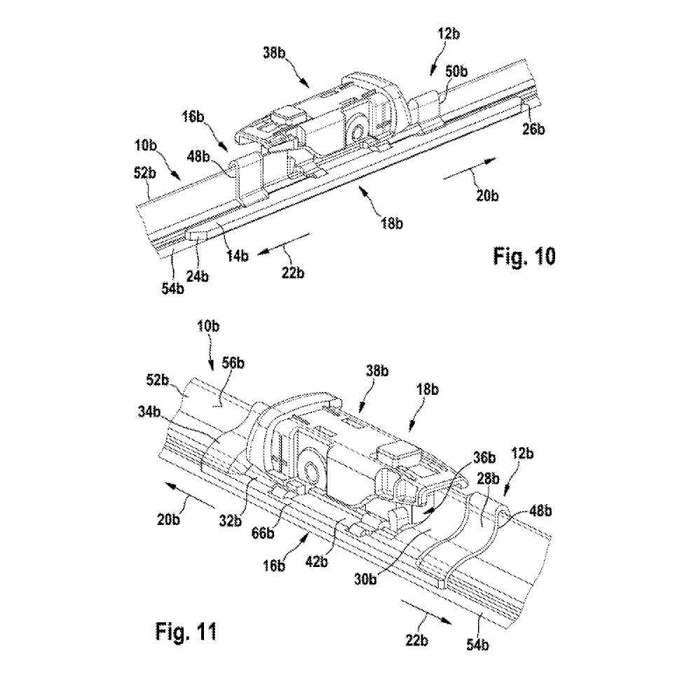

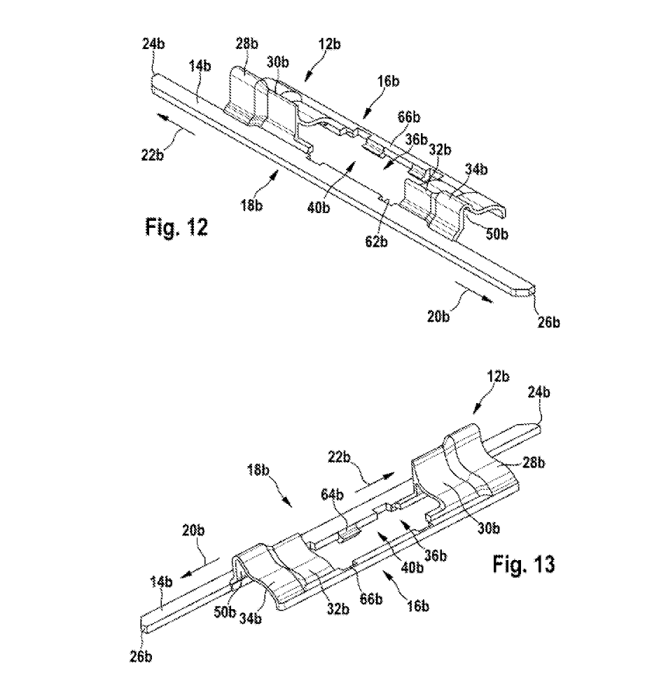

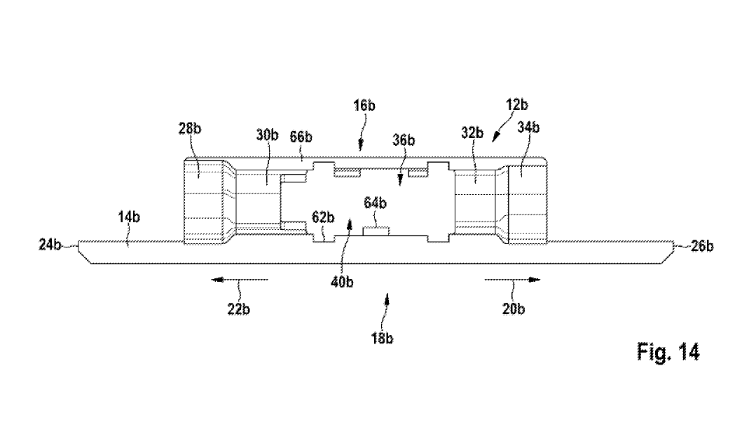

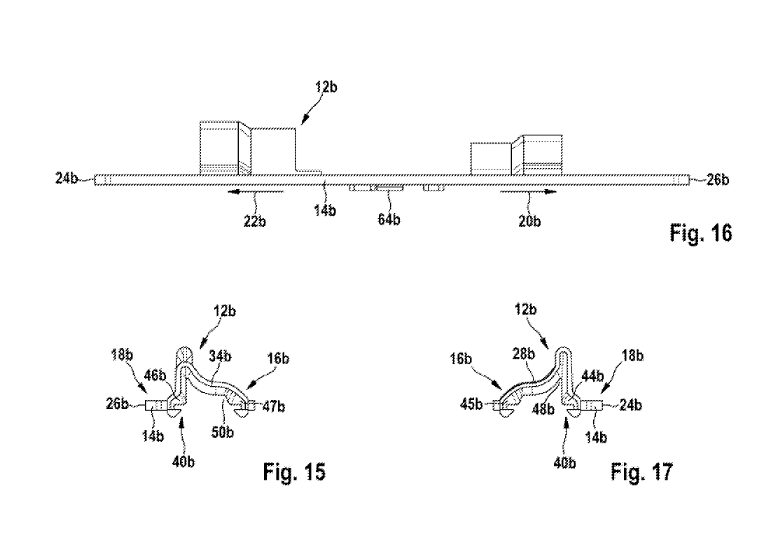

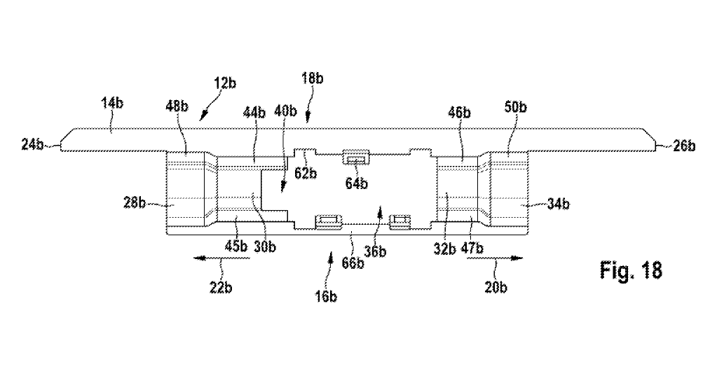

A further exemplary embodiment is shown in FIGS. 10 to 18. In order to differentiate between the exemplary embodiments, the letter a in the reference numbers of the exemplary embodiment in FIGS. 1 to 9 is replaced by the letter b in the reference numbers of the exemplary embodiment in FIGS. 10 to 18. The descriptions below are substantially restricted to the differences between the exemplary embodiments, wherein reference may be made to the description of the exemplary embodiment in FIGS. 1 to 9 with regard to components, features and functions which remain the same.

A wiper blade 10b, part of which is illustrated in FIGS. 10 and 11, has a wiper blade unit with a liquid guiding body 12b, which wiper blade unit comprises a fastening unit 40b which, in a wiper blade longitudinal direction 20b, has fastening elements 44b, 45b which are partially arranged upstream of a receiving region 36b for a wiper blade adaptor 38b, and fastening elements 46b, 47b which are arranged downstream of the receiving region 36b for the wiper blade adaptor 38b (FIGS. 10 to 18). The wiper blade unit furthermore has in each case two spoiler elements 28b, 30b, 32b, 34b upstream and downstream of the receiving region 36b for the wiper blade adaptor 38b, wherein in each case the outer spoiler elements 28b, 34b are formed by a clip, said clips each forming a receiving region 48b, 50b for a spoiler element 52b of the wiper blade 10b and, in a fitted state, extending over the spoiler element 52b (FIGS. 10, 11, 12 and 13). The second spoiler elements 30b, 32b each adjoin the spoiler elements 28b, 34b without a gap and are in each case arranged in a region of a cutout in the spoiler element 52b of the wiper blade 10b. The spoiler elements 28b, 30b, 32b, 34b are matched by the shape thereof to the spoiler element 52b and each have an S-shaped flow surface, as viewed in the wiper blade longitudinal direction 22b.

The spoiler elements 30b, 32b have fastening elements 44b, 45b, 46b, 47b of the fastening unit 40b, provided for fastening to wiper blade spring elements 42b of the wiper blade 10b, said fastening elements being formed by clamping and latching elements. The fastening elements 44b, 45b, 46b, 47b are formed by U-shaped formations into which the strip-shaped wiper blade spring elements 42b are latched during installation. In addition to the fastening elements 44b, 45b, 46b, 47b, the liquid guiding body 12b has fastening elements 64b which extend transversely with respect to the longitudinal extent of a liquid guiding bridge 14b of the liquid guiding body 12b into the receiving region 36b, which is formed by a recess, and which are latched under the wiper blade spring elements 42b during installation.

On a side of the receiving region 36b that is opposite the liquid guiding bridge 14b, the liquid guiding body 12b has a web 66b which connects the spoiler elements 30b and 32b to each other.

1. A wiper blade unit, comprising a liquid guiding body (12a; 12b) which has at least one liquid guiding bridge (14a; 14b) which, as viewed in an operating state, is arranged on a side (18a; 18b) facing away from a wiper blade main flow (16a; 16b).

2. The wiper blade unit as claimed in claim 1, characterized in that the liquid guiding bridge (14a; 14b) forms at least one end (24a, 26a; 24b, 26b) of the liquid guiding body (12a; 12b) in a wiper blade longitudinal direction (20a, 22a; 20b, 22b).

3. The wiper blade unit as claimed in claim 1, characterized in that the liquid guiding body (12a; 12b) has at least one spoiler element (28a, 30a; 32b, 34b) arranged on the wiper blade main flow side (16a; 16b).

4. The wiper blade unit as claimed in claim 1, characterized in that the liquid guiding body (12a; 12b) has at least one receiving region (36a; 36b) for a wiper blade adaptor (38a; 38b).

5. The wiper blade unit as claimed in claim 1, characterized by at least one fastening unit (40a; 40b) which is provided for fastening to at least one of a wiper blade adaptor and a wiper blade spring element (42a; 42b).

6. The wiper blade unit as claimed in claims 4, characterized in that the fastening unit (40b), as viewed in a wiper blade longitudinal direction (20b), has at least one fastening element (44b, 45b) which is at least partially arranged upstream of the receiving region (36b) for the wiper blade adaptor (38b), and at least one fastening element (46b, 47b) which is at least partially arranged downstream of the receiving region (36b) for the wiper blade adaptor (38b).

7. The wiper blade unit as claimed in claim 5, characterized in that the fastening unit (40a; 40b) has at least one clamping element.

8. The wiper blade unit as claimed in claim 1, characterized in that the liquid guiding body (12a; 12b) comprises at least one clip which has a receiving region (48a; 48b, 50b) for a spoiler element (52a; 52b).

9. A wiper blade with a wiper blade unit as claimed in claim 1, and with a wiper blade adaptor (38a; 38b).

10. The wiper blade as claimed in claim 9, characterized in that the liquid guiding bridge (14a; 14b) extends in a wiper blade longitudinal extent beyond the wiper blade adaptor (38a; 38b) in at least one wiper blade longitudinal direction (20a, 22a; 20b, 22b).

11. The wiper blade unit as claimed in claim 5, characterized in that the fastening unit (40a; 40b) has at least one latching element.

12. The wiper blade unit as claimed in claim 11, characterized in that the fastening unit (40a; 40b) has at least one clamping element.
